(19) United States
(12) Patent Application Publication
(10) Pub. No.: US 2020/0243088 A1
(43) Pub. Date: Jul. 30, 2020

(54) INTERACTION SYSTEM, INTERACTION METHOD, AND PROGRAM

(71) Applicant: Toyota Jidosha Kabushiki Kaisha, Toyota-shi Aichi-ken (JP)

(72) Inventor: Tatsuro Hori, Miyoshi-shi (JP)

(73) Assignee: Toyota Jidosha Kabushiki Kaisha, Toyota-shi Aichi-ken (JP)

(21) Appl. No.: 16/750,306

(22) Filed: Jan. 23, 2020

(30) Foreign Application Priority Data
Jan. 28, 2019 (JP) 2019-012202

(51) Int. Cl. G10L 15/22; G10L 15/26; G06F 3/16; G10L 21/04; G10L 19/02

(52) U.S. Cl. CPC G10L 15/22; G10L 15/26; G10L 19/0212; G10L 21/04; G10L 2015/223; G06F 3/167

(57) ABSTRACT

An interaction system includes: inquiry means for making an inquiry to a user by a voice; and intention determination means for determining a user's intention based on a user's voice response in response to the inquiry made by the inquiry means. When the intention determination means cannot determine a positive response, a negative response, or a predetermined keyword indicating the user's intention based on the user's voice response in response to the inquiry made by the inquiry means, the inquiry means makes an inquiry to the user again. The intention determination means determines the positive response, the negative response, or the predetermined keyword based on a user's image or a user's voice, which is a user's reaction in response to the another inquiry made by the inquiry means.

### CROSS REFERENCE TO RELATED APPLICATIONS

This application is based upon and claims the benefit of priority from Japanese patent application No. 2019-012202, filed on Jan. 28, 2019, the disclosure of which is incorporated herein in its entirety by reference.

### BACKGROUND

The present disclosure relates to an interaction system, an interaction method, and a program for making a conversation with a user.

An interaction system configured to recognize a user's voice and make a response based on results of the recognition has been known (see, for example, Japanese Unexamined Patent Application Publication No. 2008-217444).

### SUMMARY

Since the above interaction system determines the user's intention depending on the recognition of the user's voice, it is possible that the user's intention may be incorrectly determined if the voice recognition is erroneously performed.

The present disclosure has been made in order to solve the above problem, and mainly aims to provide an interaction system, an interaction method, and a program capable of accurately determining a user's intention.

One aspect of the present disclosure to accomplish the aforementioned object is an interaction system including: inquiry means for making an inquiry to a user by a voice; and intention determination means for determining a user's intention based on a user's voice response in response to the inquiry made by the inquiry means, in which, when the intention determination means cannot determine a positive response, a negative response, or a predetermined keyword indicating the user's intention based on the user's voice response in response to the inquiry made by the inquiry means, the inquiry means makes an inquiry to the user again, the intention determination means determines the positive response, the negative response, or the predetermined keyword based on a user's image or a user's voice, which is a user's reaction in response to the another inquiry made by the inquiry means.

In this aspect, the inquiry means may make the inquiry again so as to encourage the user to react by a predetermined action, facial expression, or line of sight, and the intention determination means may determine the positive response, the negative response, or the predetermined keyword by recognizing the action, the facial expression, or the line of sight of the user based on the user's image, which is the user's reaction in response to the another inquiry made by the inquiry means.

In this aspect, the interaction system may further include storage means for storing user profile information in which information indicating by which one of the action, the facial expression, and the line of sight the user should be encouraged to react to the another inquiry is set for each user, and the inquiry means may make the inquiry again so as to encourage reaction by the corresponding predetermined action, facial expression, or line of sight for each of the users based on the user profile information stored in the storage means.

In this aspect, the inquiry means may make the inquiry again so as to encourage the user to make a predetermined response by a voice, and the intention determination means may determine the positive response, the negative response, or the predetermined keyword by recognizing prosody of the user's voice based on the user's voice, which is a user's response to the another inquiry.

One aspect of the present disclosure to accomplish the aforementioned object may be an interaction method including the steps of: making an inquiry to a user by a voice; and determining a user's intention based on a user's voice response in response to the inquiry, the method including: making an inquiry to the user again when it is impossible to determine a positive response, a negative response, or a predetermined keyword indicating the user's intention based on the user's voice response in response to the inquiry; and determining the positive response, the negative response, or the predetermined keyword based on a user's image or a user's voice, which is a user's reaction in response to the another inquiry.

One aspect of the present disclosure to accomplish the aforementioned object may be a program for causing a computer to execute the following processing of: making an inquiry to a user by a voice, and making an inquiry to the user again when it is impossible to determine a positive response, a negative response, or a predetermined keyword indicating a user's intention based on a user's voice response in response to the inquiry; and determining the positive response, the negative response, or the predetermined keyword based on a user's image or a user's voice, which is a user's reaction in response to the another inquiry.

According to the present disclosure, it is possible to provide an interaction system, an interaction method, and a program capable of accurately determining a user's intention.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing a schematic system configuration of an interaction system according to a first embodiment of the present disclosure;

FIG. 2 is a flowchart showing a flow of an interaction method according to the first embodiment of the present disclosure;

FIG. 3 is a flowchart showing a flow of an interaction method according to a second embodiment of the present disclosure;

FIG. 4 is a block diagram showing a schematic system configuration of an interaction system according to a third embodiment of the present disclosure; and

FIG. 5 is a diagram showing a configuration in which an inquiry unit, an intention determination unit, and a response unit are provided in an external server.

### DETAILED DESCRIPTION

### First Embodiment

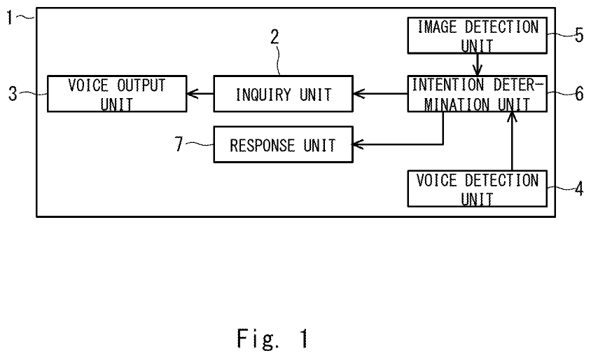

Hereinafter, with reference to the drawings, embodiments of the present disclosure will be explained. FIG. 1 is a block diagram showing a schematic system configuration of an interaction system according to a first embodiment of the present disclosure. An interaction system 1 according to the first embodiment makes a conversation with a user. The user is, for example, a patient who stays in a medical facility (a hospital or the like), a care receiver who stays in a nursing care facility or at home, or an elderly person who lives in a nursing home. The interaction system 1 is mounted on, for example, a robot, a Personal Computer (PC), or a mobile terminal (a smartphone, a tablet or the like), and makes a conversation with the user.

Incidentally, since the interaction system according to related art determines the user's intention depending on the recognition of the user's voice, it is possible that the user's intention may be falsely determined if the voice recognition is erroneously performed.

On the other hand, in the interaction system 1 according to the first embodiment, when the interaction system 1 cannot determine the intention of the user's response to the first inquiry, the interaction system 1 makes an inquiry again and determines a positive response, a negative response, or a predetermined keyword indicating the user's intention based on a user's image, which is a user's reaction in response to the above inquiry.

That is, when the interaction system 1 according to the first embodiment cannot determine the intention by the user's voice in the first inquiry, the interaction system 1 makes an inquiry again, and determines the user's intention from another viewpoint based on a user's image, which is the reaction in response to the above inquiry. In this way, by determining the user's intention by two steps, even when the voice recognition has been erroneously performed, the user's intention can be accurately determined.

The interaction system 1 according to the first embodiment includes an inquiry unit 2 configured to make an inquiry to the user, a voice output unit 3 configured to output a voice, a voice detection unit 4 configured to detect a user's voice, an image detection unit 5 configured to detect a user's image, an intention determination unit 6 configured to determine a user's intention, and a response unit 7 configured to make a response to the user.

The interaction system 1 is formed by, for example, hardware mainly using a microcomputer including a Central Processing Unit (CPU) that performs arithmetic processing and so on, a memory that is composed of a Read Only Memory (ROM) and a Random Access Memory (RAM), and stores an arithmetic program executed by the CPU and the like, an interface unit (I/F) that externally receives and outputs signals, and so on. The CPU, the memory, and the interface unit are connected with each other through a data bus or the like.

The inquiry unit 2 is one specific example of inquiry means. The inquiry unit 2 outputs a voice signal to the voice output unit 3 to cause an inquiry voice to be output to the user. The voice output unit 3 outputs the inquiry voice to the user in accordance with the voice signal transmitted from the inquiry unit 2. The voice output unit 3 is formed of a speaker or the like. The inquiry unit 2 makes an inquiry to the user by asking, for example, “What did you eat?”, “Did you eat curry?” or the like.

The voice detection unit 4 detects a user's voice response in response to the inquiry made by the inquiry unit 2. The voice detection unit 4 is formed of a microphone or the like. The voice detection unit 4 outputs the user's voice that has been detected to the intention determination unit 6.

The image detection unit 5 detects a user's image, which is a user's reaction in response to the inquiry made by the inquiry unit 2. The image detection unit 5 is formed of a CCD camera, a CMOS camera or the like. The image detection unit outputs the user's image that has been detected to the intention determination unit 6.

The intention determination unit 6 is one specific example of intention determination means. The intention determination unit 6 determines a positive response, a negative response, or a predetermined keyword indicating the user's intention based on the user's voice response in response to the inquiry made by the inquiry unit 2. The intention determination unit 6 determines the positive response, the negative response, or the predetermined keyword indicating the user's intention by performing voice recognition processing on the user's voice output from the voice detection unit 4.

The intention determination unit 6 digitizes, for example, voice information of the user in voice recognition processing, detects a speech section from the digitized information, and performs voice recognition by performing pattern matching on voice information in the detected speech section with reference to a statistical language model or the like. Note that the statistical language model is, for example, a probability model for calculating an appearance probability of a linguistic expression such as a distribution of appearances of words or a distribution of words that appear following a certain word, obtained by learning connection probabilities on a morphemic basis.

The positive response is a response that responds positively to an inquiry such as “Yes”, “Yeah”, “You are right”, “That's right” etc. The negative response is a response that responds negatively to an inquiry such as “No”, “That's not right” etc. The predetermined keyword is, for example, “curry”, “banana”, “noun of a food”. The positive response, the negative response, and the predetermined keyword are set, for example, in the intention determination unit 6 as list information, and the user can arbitrarily change the setting thereof via an input apparatus or the like.

For example, the intention determination unit 6 determines the positive response made by the user based on the user's voice response “Yes.” “Yeah.” etc. in response to the inquiry made by the inquiry unit 2 “Did you eat curry?”. The intention determination unit 6 determines the negative response made by the user based on the user's voice response “No.”, “That's not right.” etc. in response to the inquiry made by the inquiry unit 2 “Is this curry?”. The intention determination unit 6 determines the predetermined keyword “curry” indicating the user's intention based on the user's voice response “I ate curry” in response to the inquiry made by the inquiry unit 2 “What did you eat?”.

When the intention determination unit 6 cannot determine the positive response, the negative response, or the predetermined keyword indicating the user's intention based on the user's voice response in response to the inquiry detected by the voice detection unit 4, the inquiry unit 2 makes an inquiry to the user again.

When the intention determination unit 6 performs voice recognition processing on the user's voice response output from the voice detection unit 4 and cannot recognize the positive response, the negative response, or the predetermined keyword from the voice response, the intention determination unit 6 transmits a command signal to the inquiry unit 2 to make an inquiry to the user. The inquiry unit 2 makes an inquiry to the user again in accordance with the command signal from the intention determination unit 6.

When, for example, the intention determination unit 6 performs voice recognition processing on the user's voice response in response to the inquiry, “What did you eat?”, which is output from the voice detection unit 4 and cannot recognize the predetermined keyword “noun of a food” from the voice response, the intention determination unit 6 transmits a command signal to the inquiry unit 2 to make an inquiry to the user again.

In this case, it can be assumed from the content of the inquiry that the above response would include the predetermined keyword “noun of a food”. Therefore, when the intention determination unit 6 cannot recognize the predetermined keyword from the user's voice response, the intention determination unit 6 instructs the inquiry unit 2 to make an inquiry again.

When, for example, the intention determination unit 6 performs voice recognition processing on the user's voice response in response to the inquiry “Did you eat curry?”, which is an inquiry output from the voice detection unit 4 and cannot recognize from the voice response the positive response “Yes”, “Yeah” or the negative response “No”, the intention determination unit 6 transmits a command signal to the inquiry unit 2 to make an inquiry to the user again.

In this case, it can be assumed from the content of the inquiry that this response would include the positive response or the negative response. Therefore, the intention determination unit 6 instructs the inquiry unit 2 to make an inquiry again when the intention determination unit 6 cannot recognize the positive response or the negative response from the user's voice response.

The inquiry unit 2 makes an inquiry again so as to encourage the user's reaction by a predetermined action, facial expression, or line of sight. While patterns of the another inquiry for encouraging the user to make a reaction by a predetermined action, facial expression or line of sight are set, for example, in the inquiry unit 2 in advance, the setting thereof may be arbitrarily changed by the user via an input apparatus or the like.

Assume a case, for example, in which the inquiry unit 2 first makes an inquiry “Did you eat curry?” to the user. It is assumed that the intention determination unit 6 performs voice recognition processing on the user's voice response in response to the inquiry output from the voice detection unit 4 and the intention determination unit 6 cannot recognize the positive response (“Yes”, “Yeah”, “Ya” etc.) or the negative response (“No” etc.) from the voice response. In this case, the inquiry unit 2 causes the voice output unit 3 to output another inquiry voice “Can you nod if you ate curry?” so as to encourage the user to make a response by a predetermined action “nod” based on the pattern of another inquiry that has been set.

Assume a case in which the inquiry unit 2 first makes an inquiry “What did you eat?” to the user. It is assumed that the intention determination unit 6 performs voice recognition processing on the user's voice response in response to the inquiry output from the voice detection unit 4 and the intention determination unit 6 cannot recognize the predetermined keyword “noun of a food” from the voice response.

In this case, the inquiry unit 2 causes the voice output unit 3 to output another inquiry voice “Can you smile if you ate curry?” so as to encourage the user to make a reaction by a predetermined facial expression “smile” based on the pattern of another inquiry that has been set. Alternatively, the inquiry unit 2 causes the voice output unit 3 to output another inquiry voice “Can you see the right if you ate curry?” so as to encourage the user to make a reaction by a predetermined line of sight “sight direction” based on the pattern of another inquiry that has been set.

As described above, even when it is impossible to determine the intention of the user from the user's voice, a user's response by an action, facial expression, or line of sight different from voice response is obtained, and this response is determined, whereby it is possible to determine the user's intention more accurately from another viewpoint.

The image detection unit 5 detects a user's image, which is a user's reaction in response to the another inquiry made by the inquiry unit 2 described above. The intention determination unit 6 determines the positive response, the negative response, or the predetermined keyword by recognizing the action, the facial expression, or the line of sight by the user based on the image of the user's reaction in response to the another inquiry detected by the image detection unit 5.

The intention determination unit 6 is able to recognize the action, the facial expression, or the line of sight by the user by, for example, performing pattern matching processing on the image of the user's reaction. The intentidn determination unit 6 may learn the action, the facial expression, or the line of sight by the user using a neural network or the like, and recognize the action, the facial expression, or the line of sight by the user using the results of the learning.

The inquiry unit 2 causes, for example, the voice output unit 3 to output the another inquiry voice “Can you nod if you surely ate curry?” so as to encourage the user's reaction by the predetermined action “nod”. On the other hand, the intention determination unit 6 recognizes the user's action “nod” based on the image of the user's reaction detected by the image detection unit 5, thereby determining the positive response.

The inquiry unit 2 causes the voice output unit 3 to output the another inquiry voice “Can you smile if you surely ate curry?” so as to encourage the user's reaction by the predetermined facial expression “smile”. On the other hand, the intention determination unit 6 recognizes the user's facial expression “smile” based on the image of the user's reaction detected by the image detection unit 5, thereby determining the positive response.

The response unit 7 generates a response sentence based on the positive response, the negative response, or the predetermined keyword indicating the user's intention determined by the intention determination unit 6, and causes the voice output unit 3 to output the generated response sentence to the user. Accordingly, it is possible to generate a response sentence, which reflects the user's intention accurately determined by the intention determination unit 6, and output the generated response sentence, thereby smoothly making a conversation with the user. The response unit 7 and the inquiry unit 2 may be integrally formed.

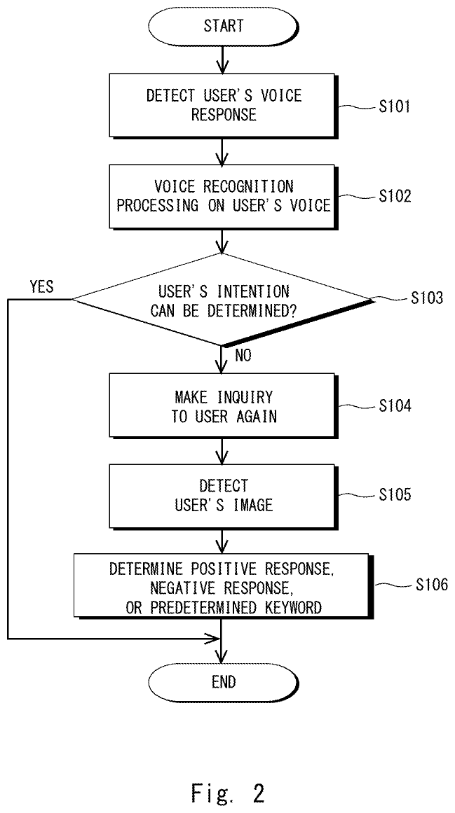

Next, a flow of an interaction method according to the first embodiment will be explained in detail. FIG. 2 is a flowchart showing the flow of the interaction method according to the first embodiment.

The voice detection unit 4 detects a user's voice response in response to the inquiry made by the inquiry unit 2, and outputs the detected user's voice response to the intention determination unit 6 (Step S101).

The intention determination unit 6 performs voice recognition processing on the user's voice output from the voice detection unit 4 (Step S102). When the intention determination unit 6 can determine the positive response, the negative response, or the predetermined keyword indicating the user's intention as a result of the voice recognition processing (YES in Step S103), the processing is ended.

On the other hand, when the intention determination unit 6 cannot determine the positive response, the negative response, or the predetermined keyword indicating the user's intention as a result of the voice recognition processing (NO in Step S103), the inquiry unit 2 makes an inquiry to the user again via the voice output unit 3 in accordance with the command signal from the intention determination unit 6 (Step S104).

The image detection unit 5 detects the user's image, which is the user's reaction in response to the another inquiry made by the inquiry unit 2 described above, and outputs the user's image that has been detected to the intention determination unit 6 (Step S105).

The intention determination unit 6 recognizes the action, the facial expression, or the line of sight by the user based on the image of the user's reaction in response to the another inquiry output from the image detection unit 5, thereby determining the positive response, the negative response, or the predetermined keyword (Step S106).

As described above, in the interaction system 1 according to the first embodiment, when the intention determination unit 6 cannot determine the positive response, the negative response, or the predetermined keyword indicating the user's intention based on the user's voice response in response to the inquiry made by the inquiry unit 2, the inquiry unit 2 makes an inquiry to the user again. The intention determination unit 6 determines the positive response, the negative response, or the predetermined keyword based on the user's image, which is a user's reaction in response to the another inquiry made by the inquiry unit 2. Accordingly, it is possible to determine the user's intention by two steps. Even when there is an error in the voice recognition, the user's intention can be accurately determined.

### Second Embodiment

In a second embodiment of the present disclosure, the inquiry unit 2 makes an inquiry again so as to encourage the user to make a predetermined response by a voice. The intention determination unit 6 recognizes prosody of the user's voice based on the user's voice, which is a user's response in response to another inquiry, thereby determining the positive response, the negative response, or the predetermined keyword. The prosody is, for example, the length of the speech of the user's voice.

By making another inquiry to encourage the user to make a predetermined response, it can be predicted that the user would make the predetermined response. Accordingly, by comparing the length of the speech of the predetermined response with the length of the speech of the actual user's response, it is possible to determine the positive response, the negative response, or the predetermined keyword.

As described above, in this second embodiment, when it is impossible to determine the intention as a result of voice recognition of the user's response in the first inquiry, an inquiry is made again, and the user's intention is determined from another viewpoint based on the prosody of the user's voice, which is the response to the inquiry. In this way, the user's intention is determined by two steps, whereby it is possible to accurately determine the user's intention.

Assume a case, for example, in which the inquiry unit 2 first makes an inquiry “What did you eat?” to the user. It is also assumed that the intention determination unit 6 performs voice recognition processing on the user's voice response in response to the inquiry output from the voice detection unit 4 and cannot recognize the predetermined keyword “noun of a food” from the voice response.

In this case, the inquiry unit 2 causes the voice output unit 3 to output another inquiry voice “Can you say “You are right” if you surely ate curry?” so as to encourage the user to make a predetermined response “You are right” based on the pattern of another inquiry that has been set.

The pattern of another inquiry that has been-set is “Can you say “You are right” if OO?”. The inquiry unit 2 determines the noun to be applied to OO in the above pattern based on information stored in a user preference database or the like. Information indicating user's preference (hobbies, likes and dislikes of food, etc.) is set in the user preference database in advance.

The voice detection unit 4 detects the user's voice “You are right”, which is the user's reaction in response to the another inquiry made by the inquiry unit 2 described above.

The length of the speech (about two seconds) of “You are right”, which is a predetermined response predicted in response to the inquiry, is set in the intention determination unit 6 in advance. The intention determination unit 6 compares the length of the speech “You are right”, which has been detected by the voice detection unit 4, with the length of the speech “You are right”, which is a predetermined response, and determines that they are consistent with each other or the difference between them is within a predetermined range. Then the intention determination unit 6 determines the noun “curry” included in the inquiry “Can you say “You are right” if you surely ate curry?” to be the predetermined keyword.

Assume a case in which the inquiry unit 2 first makes an inquiry “Did you eat curry?” to the user. It is further assumed that the intention determination unit 6 performs voice recognition processing on the user's voice response in response to the inquiry output from the voice detection unit 4 and cannot recognize the positive response “Yes” or the negative response “No” from the voice response.

In this case, the inquiry unit 2 causes the voice output unit 3 to output another inquiry voice “Can you say “I ate it” if you ate curry?” to encourage the user to make a predetermined response “I ate it” based on the pattern of another inquiry that has been set.

The voice detection unit 4 detects the user's voice “I ate it”, which is a user's reaction in response to the another inquiry made by the inquiry unit 2 described above.

The length of the speech “I ate it”, which is a predicted predetermined response in response to the inquiry, is set in the intention determination unit 6 in advance. The intention determination unit 6 compares the length of the speech of the user's voice “I ate it” detected by the voice detection unit 4 with the length of the speech “I ate it”, which is a predetermined response, and determines that they are consistent with each other or the difference between them is within a predetermined range. The intention determination unit 6 determines the response in response to the inquiry to be the positive response based on the user's response “I ate it”.

While the inquiry unit 2 makes an inquiry again to encourage the user to make a positive response “I ate it” based on the pattern of another inquiry that has been set in the above example, the inquiry unit 2 may make an inquiry again so as to encourage the user to make a negative response “I did not eat it”. In this case, the inquiry unit 2 outputs the another inquiry voice “Can you say “I did not eat it” if you did not eat curry?” so as to encourage the user to make a predetermined response “I did not eat it” based on the pattern of another inquiry that has been set.

The voice detection unit 4 detects the user's voice “I did not eat it”, which is the user's reaction in response to the another inquiry made by the inquiry unit 2 described above.

The length of the speech “I did not eat it”, which is a predicted predetermined response in response to the inquiry, is set in the intention determination unit 6 in advance. The intention determination unit 6 compares the length of the speech of the user's voice “I did not eat it”, which has been detected by the voice detection unit 4, with the length of the speech “I did not eat it”, which is a predetermined response, and determines that they are consistent with each other or the difference between them is within a predetermined range. The intention determination unit 6 determines the response in response to the inquiry to be the negative response based on the user's response “I did not eat it”.

In the second embodiment, the same components/structures as those of the first embodiment are indicated by the same symbols as those of the first embodiment and their detailed descriptions are omitted.

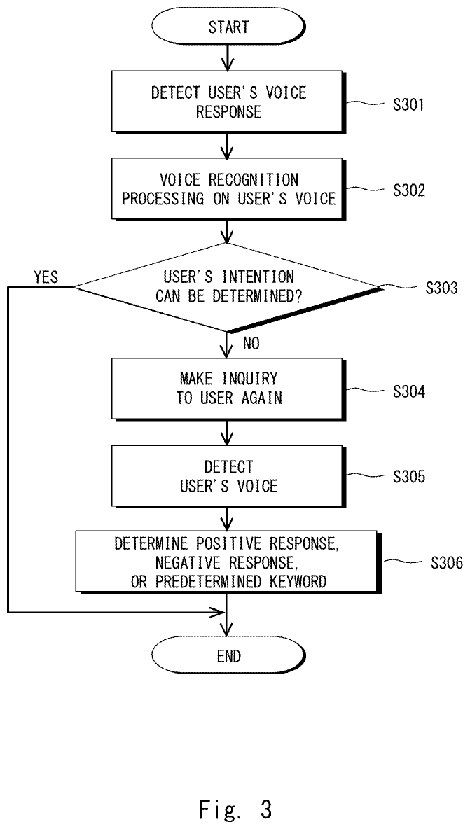

Next, a flow of an interaction method according to this second embodiment will be explained in detail. FIG. 3 is a flowchart showing a flow of the interaction method according to the second embodiment.

The voice detection unit 4 detects the user's voice response in response to the inquiry made by the inquiry unit 2 and outputs the detected user's voice response to the intention determination unit 6 (Step S301).

The intention determination unit 6 performs voice recognition processing on the user's voice output from the voice detection unit 4 (Step S302). When the intention determination unit 6 can determine the positive response, the negative response, or the predetermined keyword indicating the user's intention (YES in Step S303), this processing is ended.

On the other hand, when the intention determination unit 6 cannot determine the positive response, the negative response, or the predetermined keyword indicating the user's intention (NO in Step S303), the inquiry unit 2 makes an inquiry to the user again via the voice output unit 3 in accordance with a command signal from the intention determination unit 6 (Step S304).

The voice detection unit 4 detects the user's voice, which is the user's reaction in response to the another inquiry made by the inquiry unit 2 described above, and outputs the user's voice that has been detected to the intention determination unit 6 (Step S305).

The intention determination unit 6 recognizes the prosody of the user's voice based on the voice of the user's reaction in response to the another inquiry output from the voice detection unit 4, thereby determining the positive response, the negative response, or the predetermined keyword (Step S306).

### Third Embodiment

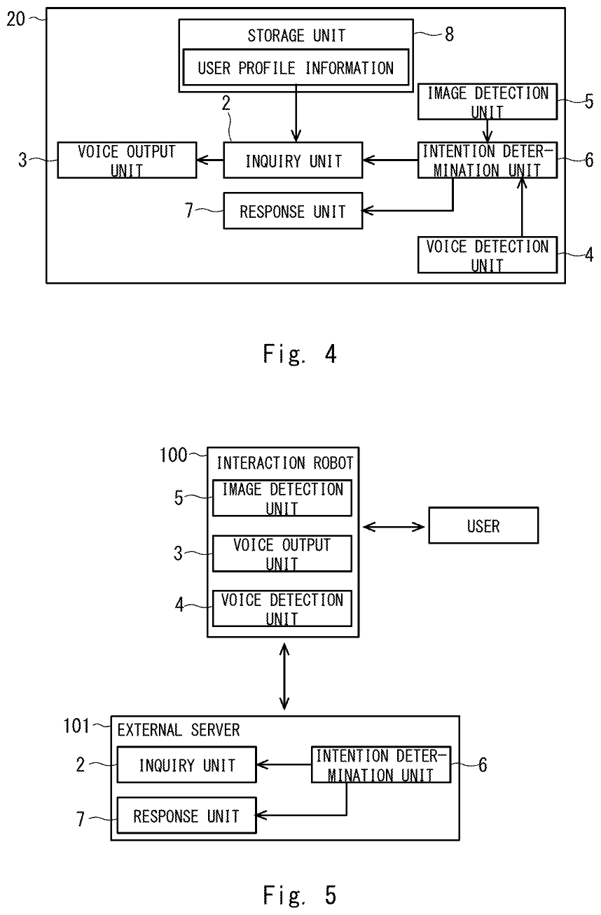

FIG. 4 is a block diagram showing a schematic system configuration of an interaction system according to a third embodiment of the present disclosure. In this third embodiment, a storage unit 8 stores user profile information in which information indicating by which one of the action, the facial expression, and the line of sight the user should be encouraged to react in response to another inquiry is set for each user. The storage unit 8 may be formed of the above-described memory.

The inquiry unit 2 makes an inquiry again so as to encourage each of the users to make a response by the corresponding predetermined action, facial expression, or line of sight based on the user profile information stored in the storage unit 8.

Every user has his/her characteristics (e.g., the user A is expressive, the motion of the user B is large, and the user C has difficulty in moving). Therefore, information is set, in the user profile information, for each user, indicating by which one of the action, the facial expression, or the line of sight the user should be encouraged to react in response to another inquiry in view of the characteristics of the respective users. Accordingly, it is possible to make an optimal inquiry considering the characteristics of the respective users, whereby it is possible to determine the user's intention more accurately.

For example, since the user A is expressive, it is set in the user profile information that another inquiry should be made to the user A so as to encourage the user A to make a reaction by a facial expression. Since the motion of the user B is large, it is set in the user profile information that another inquiry should be made to the user B so as to encourage the user B to make a reaction by an action “nod”. Since the user C has difficulty in moving, it is set in the user profile information that another inquiry should be made to the user C so as to encourage the user C to make a reaction by line of sight.

In the third embodiment, the same components/structures as those of the first and second embodiments are indicated by the same symbols as those of the first embodiment and their detailed descriptions are omitted.

Several embodiments according to the present disclosure have been explained above. However, these embodiments are shown as examples only and are not shown to limit the scope of the disclosure. These novel embodiments can be implemented in various forms. Further, their components/structures may be omitted, replaced, or modified without departing from the scope and spirit of the disclosure. These embodiments and their modifications are included in the scope and the spirit of the disclosure, and included in the scope equivalent to the disclosure specified in the claims.

While the inquiry unit 2, the voice output unit 3, the voice detection unit 4, the image detection unit 5, the intention determination unit 6, and the response unit 7 are integrally formed in the above first embodiment, this is merely an example. At least one of the inquiry unit 2, the intention determination unit 6, and the response unit 7 may be provided in an external apparatus such as an external server.

For example, as shown in FIG. 5, the voice output unit 3, the voice detection unit 4, and the image detection unit 5 are provided in the interaction robot 100, and the inquiry unit 2, the intention determination unit 6, and the response unit 7 are provided in the external server 101. Communication between the interaction robot 100 and the external server 101 is connected to each other via a communication network such as Long Term Evolution (LTE), and the interaction robot 100 and the external server 101 may perform data communication with each other. In this way, processing is separately performed by the external server 101 and the interaction robot 100, whereby it is possible to reduce the amount of processing in the interaction robot 100 and to reduce the size and the weight of the interaction robot 100.

The present disclosure can achieve, for example, the processing shown in FIGS. 2 and 3 by causing a CPU to execute a computer program.

The program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.)

The program(s) may be provided to a computer using any type of transitory computer readable media. Examples of transitory computer readable media include electric signals, optical signals, and electromagnetic waves. Transitory computer readable media can provide the program to the computer via a wired communication line (e.g., electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An interaction system comprising:
inquiry means for making an inquiry to a user by a voice; and
intention determination means for determining a user's intention based on a user's voice response in response to the inquiry made by the inquiry means, wherein,
when the intention determination means cannot determine a positive response, a negative response, or a predetermined keyword indicating the user's intention based on the user's voice response in response to the inquiry made by the inquiry means, the inquiry means makes an inquiry to the user again,
the intention determination means determines the positive response, the negative response, or the predetermined keyword based on a user's image or a user's voice, which is a user's reaction in response to the another inquiry made by the inquiry means.

2. The interaction system according to claim 1, wherein
the inquiry means makes the inquiry again so as to encourage the user to react by a predetermined action, facial expression, or line of sight, and
the intention determination means determines the positive response, the negative response, or the predetermined keyword by recognizing the action, the facial expression, or the line of sight of the user based on the user's image, which is the user's reaction in response to the another inquiry made by the inquiry means.

3. The interaction system according to claim 2, further comprising storage means for storing user profile information in which information indicating by which one of the action, the facial expression, and the line of sight the user should be encouraged to react to the another inquiry is set for each user, and
the inquiry means makes the inquiry again so as to encourage reaction by the corresponding predetermined action, facial expression, or line of sight for each user based on the user profile information stored in the storage means.

4. The interaction system according to claim 1, wherein
the inquiry means makes the inquiry again so as to encourage the user to make a predetermined response by a voice, and
the intention determination means determines the positive response, the negative response, or the predetermined keyword by recognizing prosody of the user's voice based on the user's voice, which is a user's response to the another inquiry.

5. An interaction method comprising the steps of:
making an inquiry to a user by a voice; and
determining a user's intention based on a user's voice response in response to the inquiry, the method comprising:
making an inquiry to the user again when it is impossible to determine a positive response, a negative response, or a predetermined keyword indicating the user's intention based on the user's voice response in response to the inquiry; and
determining the positive response, the negative response, or the predetermined keyword based on a user's image or a user's voice, which is a user's reaction in response to the another inquiry.

6. A non-transitory computer readable medium storing a program for causing a computer to execute the following processing of:
making an inquiry to a user by a voice, and making an inquiry to the user again when it is impossible to determine a positive response, a negative response, or a predetermined keyword indicating a user's intention based on a user's voice response in response to the inquiry; and
determining the positive response, the negative response, or the predetermined keyword based on a user's image or a user's voice, which is a user's reaction in response to the another inquiry.

7. An interaction system comprising:
an inquiry unit configured to make an inquiry to a user by a voice; and
an intention determination unit configured to determine a user's intention based on a user's voice response in response to the inquiry made by the inquiry unit, wherein,
when the intention determination unit cannot determine a positive response, a negative response, or a predetermined keyword indicating the user's intention based on the user's voice response in response to the inquiry made by the inquiry unit, the inquiry unit makes an inquiry to the user again,
the intention determination unit determines the positive response, the negative response, or the predetermined keyword based on a user's image or a user's voice, which is a user's reaction in response to the another inquiry made by the inquiry unit.
